(19) United States
(12) Patent Application Publication
(10) Pub. No.: US 2002/0054106 A1
(43) Pub. Date: May 9, 2002

(54) Graphical user interface for enabling manipulation of graphic images on a display screen

(76) Inventors: Kazuto Mugura, San Francisco, CA (US); Eduardo Sciammarella, New York, NY (US); Scott Kravitz, San Francisco, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 09/825,127

(22) Filed: Apr. 2, 2001

Related U.S. Application Data
(63) Continuation of application No. 09/539,149, filed on Mar. 30, 2000, now abandoned.
Application No. 09/539,149 is a continuation of application No. 09/006,551, filed on Jan. 13, 1998, now abandoned.

(51) Int. Cl. G09G 5/00

(52) U.S. Cl. 345/764

(57) ABSTRACT

An instrument includes a display screen which includes a bitmap graphical user interface including an on-screen menu, and a control element which enables movement of the on-screen menu corresponding to movement of the control element, enables the user to manipulate and select graphic images for executing selected instrument functions. The instrument is adapted to enable the user to focus on and select a selectable graphic image from a plurality of graphic images in the on-screen menu. The instrument is further adapted to enable display of an array of graphic images on the display screen, such that the user is able to view the array and focus on and select a selectable graphic image from the array. The instrument is further adapted to enable manipulation of a plurality of graphic elements in an on-screen menu such that the user is able to form a graphic image on the display screen. The instrument is still further adapted to enable automatic performance of instrument functions.

### BACKGROUND OF THE INVENTION

The present invention relates generally to an interface for a display screen and, more particularly, to a graphical user interface which, with a control device, enables manipulation of graphic images on a display screen.

In an instrument which includes a display screen, an on-screen menu, and a control device, a user may interact with the on-screen menu by viewing the on-screen menu, deciding to select a menu item, and manipulating the control device to generate menu movement and to enable entry of the menu selection.

The instrument may comprise a hand-held wireless telephone which includes an on-screen menu displayed in a text text-based interface on a small liquid-crystal display screen, and a jog dial control device for scrolling through the menu and for entry of a menu selection and execution of an instrument function thereby.

The small liquid crystal display screen may enable viewing of a small number of lines of text, typically two lines. The menu may include a phone book feature in which names and phone numbers may be entered, for enabling browsing and selection of an entry whereupon the phone number selected is dialed. The instrument may also include other functions, such as pager reception, two-way pager sending, or short message sending such as e-mail. However, such an instrument may require frequent selection of menu entries and instrument functions by the user through the small text-based display screen which displays a very limited number of entries. The user may choose a single item from the items displayed, and may only need to focus on the single item to be selected, but the multiple items on display increase the difficulty in selecting the single item.

Also in an instrument which includes a display screen and a control element, and which is adapted to enable a picture to be taken and transmitted to another party, a user may wish to transmit text related to the picture along with the picture.

Further, in an instrument which includes a display screen and a control element, and which is adapted to enable selection of and connection to a telephone number, a user may wish to view the name of the party called or transmit a code for enabling connection to a service.

Therefore, there has been a need existing for a system which enables the user of an instrument to view and manipulate an intuitive interface in the display, and to view movement in the interface which corresponds to movement of the control device. There has further been a need for a system which enables the user of an instrument to form a text subtitle related to a picture to be transmitted by an instrument. There has also been a need for a system which enables the user of an instrument to view the name of a party called or transmit a code required to connect with a service. The present invention fulfills these needs. cl SUMMARY OF THE INVENTION

Briefly, and in general terms, the present invention provides an on-screen menu in an interactive graphical user interface, which in several versions thereof provides for enabling manipulation of graphic images in a display screen, for enabling forming of a subtitle for a picture to be transmitted, and for enabling display of the name of a party called or transmission of a code for connection to a service.

In one version, the system enables manipulation of a plurality of graphic images on a display screen, to enable the user to focus on and select a selectable graphic image from a plurality of graphic images in the display screen, each graphic image being different from the other and movable into and out of position as the selectable graphic image. It includes a display screen. It further includes means for presenting the plurality of graphic images in the display screen, comprising a graphical user interface. It also includes means for enabling a graphic image to be a selectable graphic image. The system also includes means for enabling the user to differentiate between the selectable and other graphic images, other than by the differences between graphic images. It further includes means for enabling movement of the graphic images into and out of position as the selectable graphic image, and for enabling selection of the selectable graphic image.

In another version, the system enables display of an array of graphic images out of a plurality of graphic images on a compact display screen mounted in an instrument adapted to be held by the user in one hand, to enable the user to view, focus on and select a selectable image from the array of graphic images in the display screen. It further enables the user to locate another graphic image in the array of graphic images to be moved into position as the selectable graphic image, wherein the plurality of graphic images are each movable into and out of position as the selectable graphic image. It includes a compact display screen mounted in the hand-held instrument. It further includes means for presenting the array of multiple graphic images in the display screen, each graphic image being different from the other, which presenting means comprise a graphical user interface. It also includes means for enabling a graphic image to be a selectable graphic image. The system also includes means for enabling the user to view the array of multiple graphic images and differentiate between the selectable and other graphic images, other than by the differences between graphic images. It further includes means for enabling movement of the graphic images into and out of position as the selectable graphic image, and for enabling selection of the selectable graphic image.

In still another version, the system enables manipulation of a plurality of graphic elements on a display screen, to enable the user to form a graphic image on the display screen. It includes a display screen. It further includes means for presenting an array including a plurality of graphic images for forming the graphic image in the display screen and for presenting a line in which the graphic image is to be formed in the display screen, comprising a graphical user interface, wherein the array presenting means and line presenting means intersect at a position in which a graphic element is selectable as a part of the graphic image to be formed. It also includes means for enabling a graphic element to be a selectable graphic element. It further includes means for enabling movement of the array presenting means to move a graphic element into and out of position as the selectable graphic image in the line for forming the graphic image, and for enabling selection of the selectable graphic element.

In a further version, the system enables automatic performance of functions of an instrument. It includes means for enabling entry in the instrument of information relating to a party, and information associated with the related information. It further includes means for performing automatically an instrument function in connection with the related information and the associated information.

One aspect of the present invention is that a system enables the user to view and manipulate graphic images in an on-screen menu in an intuitive graphical user interface in a display screen.

Another aspect of the present invention is that a system enables the user to view and manipulate graphic images, and focus on and select a selectable graphic image in an on-screen menu, while being able to view an array of graphic images in a graphical user interface in a display screen.

Still another aspect of the present invention is that a system in a hand-held instrument enables the user to view, manipulate, focus on and select a selectable graphic image in an array of graphic images in an on-screen menu, in a graphical user interface on a compact display screen in the instrument.

Another aspect of the present invention is that a system enables the user of an instrument to form a graphic image on a display screen by viewing, manipulating and selecting a graphic element from an array of graphic elements in an on screen menu, to form a graphic image in a line to be formed from an on-screen menu of graphic elements in a graphical user interface in the instrument.

A further aspect of the present invention is that a system enables the user to enter information related to a party and associated with the party, and automatically execute a function in connection with the related information and the associated information through an on-screen menu in a display screen in an instrument.

Other features and advantages of the invention will become apparent from following detailed description taken in conjunction with the accompanying drawings, which illustrate, by way of example, the features of the invention.

### BRIEF DESCRIPTION OF THE DRAWINGS

FIG. 1 is an elevational view illustrating an initial display in an instrument which includes an on-screen menu for viewing, focusing on, manipulating, and selecting a selectable graphic image in accordance with the present invention;

FIG. 2 is an elevational view of another display in an instrument which includes an on-screen menu in accordance with the present invention;

FIG. 3 is an elevational view of a further display in an instrument which includes an on-screen menu in accordance with the present invention;

FIG. 4 is an elevational view of a still further display in an instrument which includes an on-screen menu in accordance with the present invention;

FIG. 5 is an elevational view of an on-screen menu in a display screen in accordance with the present invention;

FIG. 6 is an elevational view of another on-screen in a display screen in accordance with the present invention;

FIG. 7 is an elevational view illustrating an initial display in an instrument which includes an on-screen menu for viewing, focusing on, manipulating and selecting a selectable graphic element to form a graphic image in accordance with the present invention;

FIG. 8 is an elevational view of another display in an instrument which includes an on-screen menu for forming a graphic image in accordance with the present invention;

FIG. 9 is an elevational view of a further display in an instrument which includes an on-screen menu for forming a graphic image in accordance with the present invention;

FIG. 10 is an elevational view illustrating an on-screen menu in a display screen in an initial position for forming a graphic image in accordance with the present invention;

FIG. 11 is an elevational view of an on-screen menu in a display screen in another position for forming a graphic image in accordance with the present invention;

FIG. 12 is an elevational view of an on-screen menu in a display screen in a further position for forming a graphic image in accordance with the present invention;

FIG. 13 is an elevational view of an on-screen menu in a display screen in another position for forming a graphic image in accordance with the present invention;

FIG. 14, is an elevational view of an on-screen menu in a display screen in a still further position for forming a graphic image in accordance with the present invention;

### DETAILED DESCRIPTION OF THE PREFERRED EMBODIMENTS

Referring now to the drawings, there are shown preferred embodiments of a system 10 for enabling manipulation of a plurality of graphic images 12 on a display screen 14.

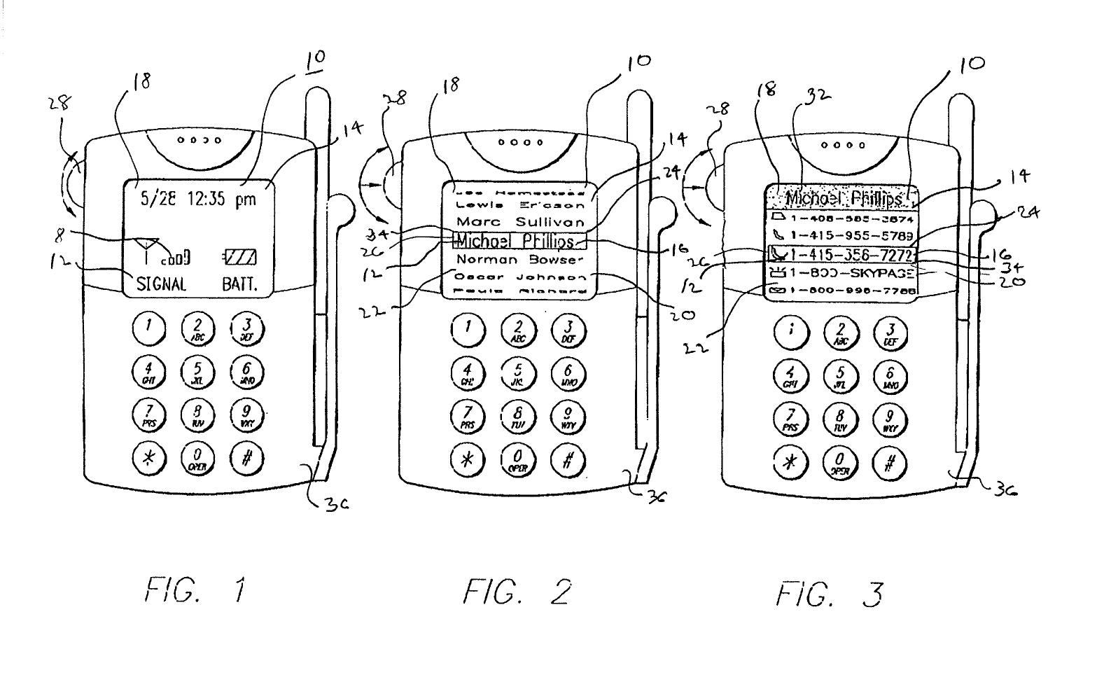

In a preferred embodiment as shown in FIGS. 1-6, system 10 is adapted to enable a user to focus on and select a selectable graphic image 16 from the plurality of graphic images 12 on display screen 14. In system 10, the plurality of graphic images 12 are each movable into and out of a position as a selectable graphic image 16. Each graphic image 12 is different from the other graphic images 12. Graphic images 12 may comprise alphabetical images, numerical images, and icons. A graphical user interface 18 which comprises a bitmap display includes the plurality of graphic images 12 therein, and presents an array 20 of the plurality of graphic images 12 in display screen 14. Graphical user interface 18 may comprise a menu 22 which includes the plurality of graphic images 12 and selectable graphic image 16 therein. Array 20 of graphic images 12 presented in display screen 14 may comprise at least five graphic images, and preferably comprise seven graphic images 12. Menu 22 is scrollable, appears to occupy three-dimensional space, and appears to be a rotatable wheel including a rounded wheellike surface in a wheel metaphor. A cursor 24 enables a graphic image 12 to be positionable in a position 26 in graphical user interface 18 so as to be a selectable graphic image 16. A jog dial 28 is rotatable and pressable, to enable movement of the plurality of graphic images 12 into and out of position as selectable graphic image 16, and to enable selection of selectable graphic image 16 in display screen 14. Rotation of jog dial 28 results in corresponding rotation of graphic images 12 in display screen 14.

System 10 enables a user to differentiate between the plurality of graphic images 12 and selectable graphic image 16, and to focus on and select one of the plurality of graphic images 12 as selectable graphic image 16. For example, one of the plurality of graphic images 12 may appear as an enlarged image relative to the other graphic images 12, upon moving such graphic image 12 into position as selectable graphic image 16. The enlarged image enables the user to differentiate between selectable graphic image 16 and the other graphic images 12, other than by the differences between graphic images 12, and enables the user to focus on selectable graphic image 16. In the preferred embodiment, the font size of the graphic image 12 which has been moved into position as selectable graphic image 16 is greater than the other graphic images 12. The differentiating font size may comprise the height of the font, in that the height of the font of the graphic image 12 which has been moved into position as selectable graphic image 16 may be greater than the height of the fonts of graphic images 12 other than selectable graphic image 16. Alternatively, for example, menu 22 may include a color background for each graphic image 12 and selectable graphic image 16, with the color background for selectable graphic image 16 being different from the color background for the other graphic images 12, to enable the user to differentiate therebetween.

System 10 also enables the user to view array 20 of the plurality of graphic images 12 in display screen 14, so that the user may be aware of, focus on, and select one of array 20 of graphic images 12 as selectable graphic image 16, by rotation of menu 22 to move the selected graphic image 12 into position 26 as selectable graphic image 16. In the preferred embodiment, the font sizes of graphic images 12 other than selectable graphic image 16 decrease with increasing distance from selectable graphic image 16, enabling the user to view array 20 of graphic images 12 in display screen 14. The font size may comprise the height of the fonts of graphic images 12 other than selectable graphic image 16, which font size may decrease with increasing distance from selectable graphic image 16.

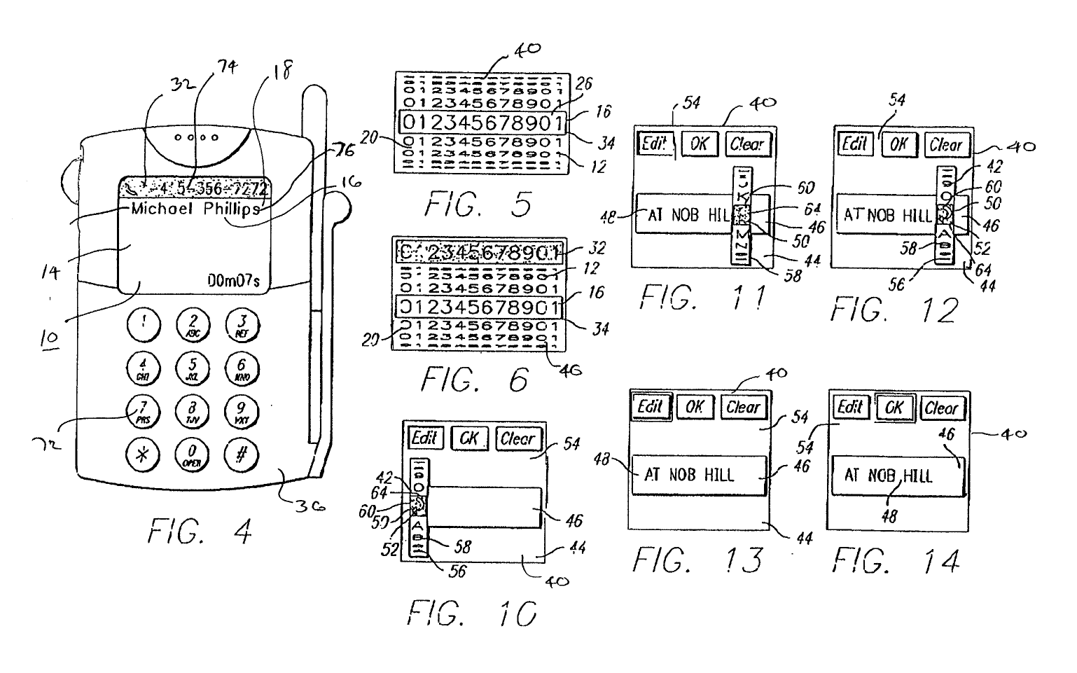

Display screen 14 preferably comprises a bitmap screen for presenting graphical user interface 18. It may comprise a liquid crystal display screen, and may comprise a color display screen. Selectable graphic image 16 is preferably positionable in substantially the center of display screen 14. Movement of one of the plurality of graphic images 12 out of position as selectable graphic image 16 moves such graphic image 12 to the next position which is adjacent to position 26 for selectable graphic image 16. Menu 22 includes a plurality of spaces 30, each of which includes a graphic image 12 therein. Menu 22 may present a different plurality of graphic images 12 and selectable graphic image 16 in each screen as shown in FIGS. 24. In the screen shown in FIG. 4, a header graphic image 32 is also presented.

Cursor 24 may preferably include an outline 34 which extends about selectable graphic image 16, or may be adapted to highlight selectable graphic image 16, as by flashing selectable graphic image 16. Position 26 of selectable graphic image 16 may preferably be in substantially the center of display screen 14.

Jog dial 28 may be rotatable such that rotation thereof results in corresponding rotation of the plurality of graphic images 12 in display screen 14, and may also be pressable to select the selectable graphic image 18. Jog dial 28 may preferably be located on the side of an instrument which may comprise a wireless telephone 36 in which a compact display screen 14 may be mounted, enabling manipulation of jog dial 28 with the thumb of the user, or may be located in the back of wireless telephone 36 enabling manipulation of jog dial 28 with the forefinger of the user.

Wireless telephone 36 is adapted to perform a plurality of functions which may include dialing a telephone number, paging, and sending a message. It includes graphic level indicators 38 for indicating for example the level of signal strength and battery charge, and may further include graphic images (not shown) for enabling direct access to several instrument functions. Also, the plurality of graphic images 12 and selectable graphic image 16 in a menu 22 each enable access to a function, either directly, or indirectly by enabling access to another menu 22 which enables access to the function. Wireless telephone 36 is adapted to be held by the user in one hand, and to enable manipulation of jog dial 26 with one finger.

In operation, for example, wireless telephone 36 may be held in one hand by the user, jog dial 28 may be manipulated by one finger of the user, and wireless telephone 36 may be activated by turning on a power switch (not shown). The power switch may activate display screen 14 which may comprise a bitmap screen including graphical user interface 18 in a liquid crystal display screen 14, to present for example the screen shown in FIG. 1, which may display the date and time of day and graphic level indicators 36 for indicating instrument levels.

Accessing the next screen as shown in FIG. 2 may present menu 22 in display screen 14, including graphic images 12 and selectable graphic image 16 in menu 22. Selectable graphic image 16 may be presented as the largest of the plurality of graphic images 12 in display screen 14, in that the height of the font of selectable graphic image 16 may be greater than the height of the fonts of graphic images 12 other than selectable graphic image 16, to enable the user to differentiate between selectable graphic image 16 and the other graphic images 12 so as to focus on selectable graphic image 16, as shown in FIGS. 2-6. Also, the height of the fonts of graphic images 12 may decrease with increasing distance from selectable graphic image 16, to enable the user to be aware of and focus on one of array 20 of graphic images 12 as selectable graphic image 16. Selection of selectable graphic image 16 is enabled by cursor 24 which may be positioned at position 26 in substantially the center of display screen 14 in menu 22, in which selectable graphic image 16 may be positioned.

Rotating jog dial 28 results in corresponding rotation of menu 22, which is scrollable and appears to be a three-dimensional rotatable wheel including a rounded wheel-like surface, so as to move a graphic image 12 which is in position 26 as selectable graphic image 16 out of position 26, and moves the next adjacent graphic image 12 into position as selectable graphic image 16. Pressing job dial 28 generates selection of selectable graphic image 16, enabling access to the function represented by selectable graphic image 16. For example, pressing jog dial 28 while in the screen shown in FIG. 2 wherein the “phonebook” is the selectable graphic image 16 enables access to the “phonebook” screen shown in FIG. 3. Next, pressing jog dial 28 while in the screen shown in FIG. 3 wherein “Michael Phillips” is the selectable graphic image 16 enables access to the screen shown in FIG. 4 which includes the “Michael Phillips” header graphic image 32. Then pressing jog dial 28 enables access to the dialer function of wireless telephone 36 to dial the telephone number which is selectable graphic image 16 in menu 22.

In a preferred embodiment as shown in FIGS. 2-6, system 10 is further adapted to enable a user to view array 20 of multiple graphic images 12, out of the plurality of graphic images 12, on display screen 14 in instrument 36. It enables the user to view, focus on, and select selectable graphic image 16 from array 20, and to view the multiple graphic images 12 in array 20 other than selectable graphic image 16, to locate another graphic image 12 which may be desired to be moved into position 26 as selectable graphic image 16. Display screen 16 may be a compact display screen which may comprise a bitmap screen for presenting graphical user interface 18, and instrument 36 may be a hand-held instrument which may comprise a wireless telephone.

The font sizes of multiple graphic images 12 other than selectable graphic image 16 may decrease with increasing distance from selectable graphic image 16, enabling the user to view array 20 of graphic images 12 in display screen 14. The font size may comprise the height of the fonts of graphic images 12 other than selectable graphic image 16, which font size may decrease with increasing distance from selectable graphic image 16.

The multiple graphic images 12 in array 20 on display screen 14 may comprise at least three graphic images 12, and preferably comprise seven graphic images 12.

In operation, for example, wireless telephone 36 may be activated, with multiple graphic images 12 displayed in display screen 14. The height of the fonts of multiple graphic images 12 may decrease with increasing distance from selectable graphic image 16, to enable at least three graphic images 12, and preferably seven graphic images 12, to be displayed in display screen 14, so as to enable the user to view, focus on, and select selectable graphic image 16 from array 20, and to locate another graphic image which may be desired to be moved into position 26 as selectable graphic image 16.

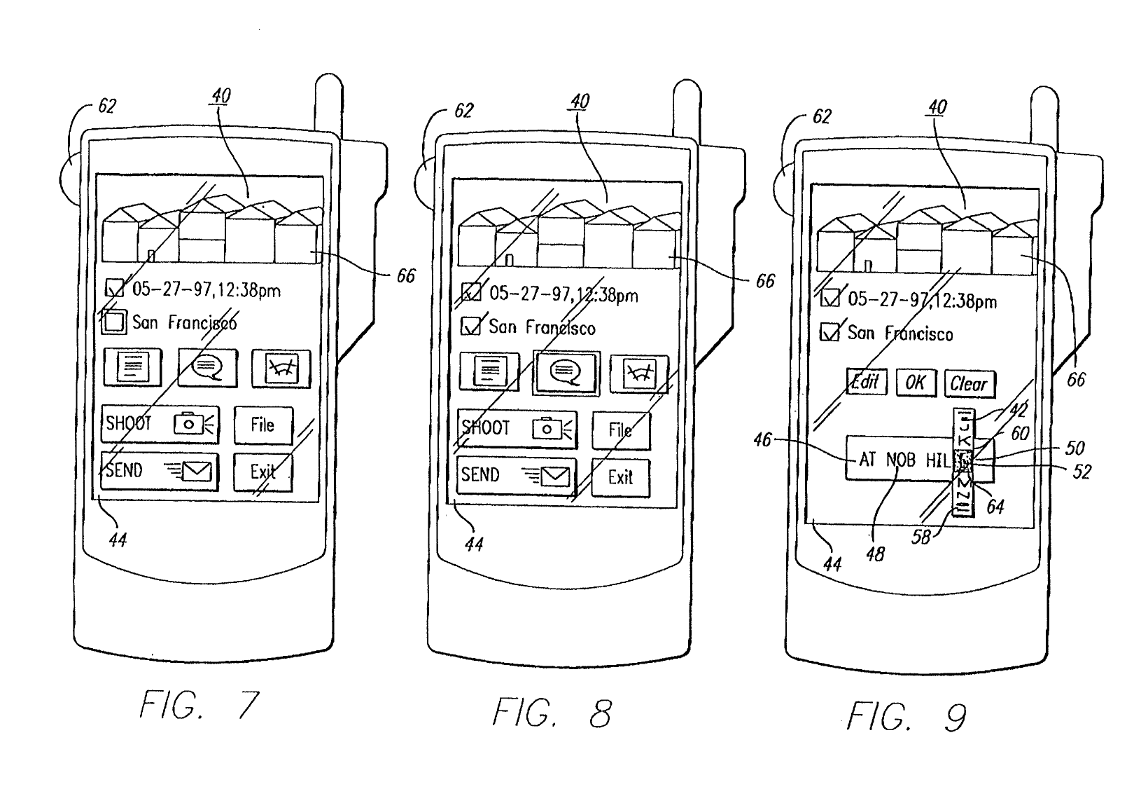

In a further preferred embodiment as shown in FIGS. 7-14, system 40 is adapted to enable manipulation of a plurality of graphic elements 42 on a display screen 44, to enable a user to form a line 46 which comprises a graphic image 48 in display screen 44. In system 40, the plurality of graphic elements 42 are each movable into and out of a position 50 as a selectable graphic element 52, to form a part of graphic image 48 in line 46. Each graphic element 42 is different from the other graphic elements 42. Graphic elements 42 may comprise alphabetical elements, numerical elements, and icons. A graphical user interface 54 includes the plurality of graphic elements 42 therein, and presents an array 56 of the plurality of graphic elements 42 in display screen 44. Graphical user interface 54 may comprise a wheel image 58 which includes the plurality of graphic elements 42 and selectable graphic element 52 therein. Wheel 58 may be rotatable and scrollable, and may be movable to adjacent positions along line 46. Line 46 and wheel image 58 intersect at position 50 wherein a graphic element 42 is selectable as selectable graphic element 52 to form a part of graphic image 48. A cursor 60 enables a graphic element 42 to be positionable in position 50 in graphical user interface 54 so as to be a selectable graphic element 52. A jog dial 62 is rotatable and pressable, to enable movement of the plurality of graphic images 42 into and out of position as selectable graphic element 52, and to enable selection of selectable graphic element 52 in display screen 44. Rotation of jog dial 62 results in corresponding rotation of graphic elements 42 in display screen 44.

System 40 enables a user to manipulate the plurality of graphic elements 42 in display screen 44. For example, the plurality of graphic elements 42 may comprise letters of the alphabet and numbers, enabling a selected letter or number to form a part of graphic image 48, the parts of which together may comprise a word or a numerical address.

System 40 also enables the user to take and send a picture 64, with line 46 and graphic image 48 therein comprising a subtitle for picture 64 which may also be sent along with picture 64. Picture 64 may be taken with a CCD camera, not shown, which may be mounted in an instrument 66. The camera may be operated by buttons 68 in display screen 44, which buttons 68 may be accessible in the screens shown in FIGS. 7-8. Instrument 66 may comprise a wireless telephone.

Display screen 44 preferably comprises a bitmap screen for presenting graphical user interface 54. It may comprise a liquid crystal display screen, and may comprise a color display screen. Movement of one of the plurality of graphic elements 42 out of position as selectable graphic element 52 moves such graphic element 42 to the next position in wheel 58 which is adjacent to position 50 for selectable graphic element 52.

Cursor 60 may include an outline 70 which extends about selectable graphic element 52, or may be adapted to highlight selectable graphic element 52, as by flashing selectable graphic element 52. Position 50 of selectable graphic element 52 may preferably be in substantially the center of display screen 44.

Jog dial 62 may be rotatable such that rotation thereof results in corresponding rotation of the plurality of graphic elements 42 in display screen 44, and may also be pressable to select the selectable graphic element 52. Jog dial 62 may preferably be located on the side of instrument 66 in which a compact display screen 44 may be mounted, enabling manipulation of jog dial 62 with the thumb of the user, or may be located in the back of instrument 66 enabling manipulation of jog dial 28 with the forefinger of the user.

In operation, for example, instrument 66 may be held in one hand by the user, jog dial 62 may be manipulated by one finger of the user, and instrument 66 may be activated by turning on a power switch (not shown). The power switch may activate display screen 44 which may comprise a bitmap screen including graphical user interface 54 in a liquid crystal display screen 44, to present for example the screen shown in FIGS. 7-8 which may display picture 64 taken with the CCD camera in instrument 66, and buttons 68 for performing functions relating thereto.

Accessing the next screen as shown in FIG. 9 may present graphic elements 42 in wheel 58 and selectable graphic element 52 and graphic image 48 in line 46.

Rotating jog dial 62 results in corresponding rotation of wheel 58 which is scrollable and appears to be a three-dimensional rotatable wheel including a rounded wheel-like surface, so as to move a graphic element 42 which is in position 50 as selectable graphic element 52 out of position 50, and moves the next adjacent graphic element 42 into position as selectable graphic element 52. Pressing jog dial 62 generates selection of selectable graphic element 52 to form a part of graphic image 48. For example, pressing jog dial 62 while in the screen shown in FIG. 9 enables selection of the letter “L” as part of graphic image 48 “AT NOB HILL” in line 46, as the subtitle for picture 64. Then wheel 58 moves to the next adjacent position in line 46 for selection of the next selectable graphic element 52, and the process is repeated. Upon completion of graphic image 48, picture 64 with the subtitle formed in line 46 may be sent as desired by the user.

In another preferred embodiment, as shown in FIG. 4, system 10 is adapted to enable automatic performance of functions of an instrument 36. For example, instrument 36 may comprise a wireless telephone, which includes elements 72, such as a keypad, for enabling entry of information 74 relating to a party, such as the telephone number of the party, and information 76 associated with the party, such as the name of the party. Instrument 36 further includes a display screen 14, for displaying related information 74 and associated information 76. Instrument 36 is adapted to automatically display the name of the party associated with the telephone number of the party, upon entry of the telephone number of the party.

Instrument 36 may further or alternatively comprise a pager, which is adapted to connect instrument 36 to the telephone number entered, wherein related information 36 may comprise the telephone number of a paging service. Associated information 76 may comprise a personal identification number. Instrument 36 may then be adapted to automatically transmit the personal identification number to the paging service, upon connection of the entered telephone number with the paging service, for enabling connection of instrument 36 to the paging service.

From the foregoing it will be appreciated that the system of the present invention provides advantages in enabling manipulation of a plurality of graphic images on a display screen. While particular forms of the invention have been illustrated and described, it will be apparent that various modifications can be made without departing from the spirit and scope of the invention. Accordingly, the invention is not to be limited, except as by the following claims.

In the claims:

1. A system for enabling manipulation of a plurality of graphic images on a display screen, to enable a user to focus on and select a selectable graphic image from a plurality of graphic images in the display screen, wherein the plurality of graphic images are each movable into and out of a position as the selectable graphic image, the system comprising:
a display screen;
means for presenting a plurality of graphic images in the display screen, wherein each graphic image is different from the other graphic images and the plurality of graphic images are each movable into and out of a position as the selectable graphic image, comprising a graphical user interface;
means for enabling a graphic image to be a selectable graphic image, which graphic image is movable into the selectable position in the presenting means;
means for enabling the user to differentiate between the graphic image positioned as the selectable graphic image and the graphic images other than the selectable graphic image in the display screen other than by the differences between the graphic images; and
means for enabling movement of the plurality of graphic images into and out of the position as the selectable graphic image, and for enabling selection of the selectable graphic image in the display.

2. The system of claim 1, wherein the differentiating means comprise means for enabling the user to focus on the selectable graphic image.

3. The system of claim 1, wherein the differentiating means comprise the selectable graphic image adapted to appear as an enlarged image relative to the other images in the plurality of graphic images.

4. The system of claim 1, wherein the differentiating means comprise the size of the graphic image fonts, such that the selectable graphic image is comprised of a font size which is larger than the other graphic images in the plurality of graphic images.

5. The system of claim 1, wherein the differentiating means comprise the size of the graphic image fonts, such that the graphic images other than the selectable graphic image are comprised of font sizes which decrease with increasing distance from the selectable graphic image.

6. The system of claim 1, wherein the display screen comprises a bitmap screen.

7. The system of claim 1, wherein the graphical user interface comprises a menu which includes the plurality of graphic images and selectable graphic image therein.

8. The system of claim 1, wherein the graphic image selectability enabling means comprise a cursor in which a graphic image is positionable for enabling the graphic image to be selectable.

9. The system of claim 1, wherein the movement enabling means are rotatable such that rotation thereof results in corresponding rotation of the graphic images in the display screen.

10. The system of claim 1, wherein the movement enabling means comprise a jog dial which is rotatable and pressable.

11. The system of claim 1, wherein movement of the movement enabling means, to move a graphic image out of position as the selectable graphic image moves the graphic image to the next position adjacent the selectable graphic image position.

12. The system of claim 1, further comprising an instrument in which the display screen is mounted, which instrument is adapted to perform a plurality of functions, wherein at least one of the graphic images represents a function of the instrument accessible by selection thereof, such that selection of the graphic image which enables access to the function as the selectable graphic image enables access to the instrument function represented thereby.

13. The system of claim 1, further comprising an instrument in which the display screen is mounted, wherein the instrument is adapted to be held by the user in one hand, and the movement enabling means are adapted to be manipulated by the user with one finger.

14. The system of claim 1, wherein the display screen comprises a liquid crystal display screen.

15. The system of claim 1, wherein the display screen comprises a color display screen.

16. The system of claim 1, wherein the selectable graphic image is positionable in substantially the center of the display screen.

17. The system of claim 1, further comprising a header position in the presenting means wherein a graphic image positioned therein comprises a header graphic image.

18. The system of claim 1, wherein the plurality of graphic images include alphabetical graphic images.

19. The system of claim 1, wherein the plurality of graphic images include numerical graphic images.

20. The system of claim 1, wherein the plurality of graphic images include icons.

21. The system of claim 3, wherein the image which appears to be enlarged appears to be a magnified image.

22. The system of claim 4, wherein the differentiating means further comprise the size of the graphic image fonts, such that the graphic images other than the selectable graphic image are comprised of font sizes which decrease with increasing distance from the selectable graphic image.

23. The system of claim 4, wherein the font size comprises the height of the font, and the differentiating means comprise the height of the font of the selectable graphic image being greater than the font size of graphic images other than the selectable graphic image.

24. The system of claim 5, wherein the font size comprises the height of the font, and the differentiating means comprise the height of the fonts of the graphic images other than the selectable graphic image which decrease with increasing distance from the selectable graphic image.

25. The system of claim 7, wherein the menu appears to occupy three-dimensional space.

26. The system of claim 7, wherein the menu is scrollable.

27. The system of claim 7, wherein the menu includes a plurality of spaces, each of which includes a graphic image therein.

28. The system of claim 8, wherein the cursor comprises an outline of the selectable graphic image.

29. The system of claim 8, wherein the cursor includes means for highlighting the selectable graphic image.

30. The system of claim 9, wherein the movement enabling means are pressable such that pressing thereof results in selection of the selectable graphic image.

31. The system of claim 10, further comprising an instrument in which the display screen is mounted, wherein the jog dial is located on a side of the instrument.

32. The system of claim 10, further comprising an instrument in which the display screen is mounted, wherein the jog dial is located in the back of the instrument.

33. The system of claim 12, wherein the instrument comprises a wireless telephone.

34. The system of claim 15, wherein the graphical user interface comprises a menu which includes the plurality of graphic images and the selectable graphic image, and the menu includes a color background for the selectable graphic image and for the other graphic images, and the differentiating means comprise the color background for the selectable graphic image being different from the color backgrounds of the other graphic images.

35. The system of claim 22, wherein the font size comprises the height of the font, and the differentiating means comprise the height of the fonts of the graphic images other than the selectable graphic image which decrease with increasing distance from the selectable graphic image.

36. The system of claim 25, wherein the menu appears to be a wheel which is rotatable.

37. The system of claim 25, wherein the menu three-dimensional space appears to include a rounded surface.

38. The system of claim 29, wherein the highlighting means comprise means for flashing the selectable graphic image.

39. The system of claim 30, wherein the movement enabling means comprise a jog dial which is rotatable and pressable.

40. The system of claim 33, wherein the instrument function comprises dialing a telephone number.

41. The system of claim 33, wherein the instrument function comprises paging.

42. The system of claim 36, wherein the instrument function comprises sending a message.

43. The system of claim 39, further comprising an instrument in which the display screen is mounted, wherein the instrument is adapted to be held by the user in one hand, and the jog dial is adapted to be manipulated by the user with one finger.

44. The system of claim 43, further comprising an instrument in which the display screen is mounted, wherein the jog dial is located on a side of the instrument.

45. The system of claim 43, further comprising an instrument in which the display screen is mounted, wherein the jog dial is located in the back of the instrument.

46. The system of claim 44, wherein the jog dial is adapted to be manipulated by the thumb of the user.

47. The system of claim 45, wherein the jog dial is adapted to be manipulated by the forefinger of the user.

48. A method of enabling manipulation of a plurality of graphic images on a display screen, to enable a user to focus on and select a selectable graphic image from a plurality of graphic images in the display screen, wherein the plurality of graphic images are each movable into and out of a position as the selectable graphic image, the method comprising:
activating a display screen in a system which includes the display screen, means for presenting a plurality of graphic images in the display screen, wherein each graphic image is different from the other graphic images and the plurality of graphic images are each movable into and out of a position as the selectable graphic image, comprising a graphical user interface, means for enabling a graphic image to be a selectable graphic image, which graphic image is movable into the selectable position in the presenting means, means for enabling the user to differentiate between the graphic image positioned as the selectable graphic image and the graphic images other than the selectable graphic image in the display screen other than by the differences between the graphic images, and means for enabling movement of the plurality of graphic images into and out of the position as the selectable graphic image, and for enabling selection of the selectable graphic image in the display;
presenting the plurality of graphic images in the display;
moving the movement enabling means to move a graphic image into and out of position as the selectable graphic image wherein movement of a graphic image into position as the selectable graphic image enables the user to select the selectable graphic image; and
activating the movement enabling means to select the selectable graphic image in the display.

49. The method of claim 48, wherein the differentiating means comprise means for enabling the user to focus on the selectable graphic image and the step of activating the movement enabling means comprises selecting the selectable graphic image which the selectable graphic image enabling means enable the user to focus on.

50. The method of claim 48, wherein the differentiating means comprise the selectable graphic image adapted to appear as an enlarged image relative to the other images in the plurality of graphic images, and the step of presenting the plurality of graphic images comprises presenting the selectable graphic image so as to appear as an enlarged image relative to the other images in the plurality of graphic images.

51. The method of claim 48, wherein the differentiating means comprise the size of the graphic image fonts, such that the selectable graphic image is comprised of a font size which is greater than the other images in the plurality of graphic images, and the step of activating the movement enabling means comprises selecting the selectable graphic image font size.

52. The method of claim 48, wherein the differentiating means comprise the size of the graphic image fonts, such that the graphic images other than the selectable graphic image are comprised of font sizes which decrease with increasing distance from the selectable graphic image, and the step of presenting the plurality of graphic images comprises presenting the graphic images other than the selectable graphic image in font sizes which decrease with increasing distance from the selectable graphic image.

53. The method of claim 48, wherein the display screen comprises a bitmap screen, and the step of activating the display screen comprises activating the bitmap screen.

54. The method of claim 48, wherein the graphical user interface comprises a menu which includes the plurality of graphic images and selectable graphic image therein, and the step of presenting the plurality of graphic images comprises presenting the menu.

55. The method of claim 48, wherein the graphic image selectability enabling means comprise a cursor in which a graphic image is positionable for enabling the graphic image to be selectable, and the step of activating the display screen comprises activating the cursor.

56. The method of claim 48, wherein the movement enabling means are rotatable and pressable such that rotation thereof results in corresponding rotation of the menu in the display screen, and pressing thereof results in selection of the selectable graphic image, and the steps of moving and activating the movement enabling means comprise rotating the menu and selecting the selectable graphic image.

57. The method of claim 48, wherein the movement enabling means comprise a jog dial which is rotatable and pressable, and the steps of moving and activating the movement enabling means comprises activating the jog dial.

58. The method of claim 48, wherein movement of the movement enabling means, to move a graphic image out of position as the selectable graphic image, moves the graphic image to the next position adjacent the selectable graphic image position, and the step of moving the movement enabling means comprises moving a graphic image into the next position adjacent the selectable graphic image.

59. The method of claim 48, wherein the system further comprises an instrument in which the display screen is mounted, which instrument includes a plurality of functions performable thereby, wherein at least one of the graphic images represents a function of the instrument accessible by selection thereof, such that selection of the graphic image which enables access to the function as the selectable graphic image enables access to the instrument function represented thereby, and the step of activating the movement enabling means comprises accessing the instrument function represented by the selectable graphic image.

60. The method of claim 48, wherein the system further comprises an instrument in which the display screen is mounted, wherein the instrument is adapted to be held by the user in one hand, and the movement enabling means are adapted to be manipulated by the user with one finger, and the steps of moving and activating the movement enabling means comprise manipulating the movement enabling means with one finger of the user.

61. The method of claim 48, wherein the display screen comprises a liquid crystal display screen, and the step of activating the display screen comprises activating the liquid crystal display screen.

62. The method of claim 48, wherein the display screen comprises a color display screen, and the step of activating the display screen comprises activating a color display screen.

63. The method of claim 48, wherein the selectable graphic image is positionable in substantially the center of the display screen, and the step of presenting the plurality of graphic images comprises presenting the selectable graphic image in substantially the center of the display.

64. The method of claim 48, further comprising a header position in the presenting means wherein a graphic image positioned therein comprises a header graphic image, and the step of presenting the plurality of graphic images comprises presenting the header graphic image.

65. The method of claim 48, wherein the plurality of graphic images include alphabetical graphic images, and the step of presenting the plurality of graphic images comprises presenting the plurality of alphabetical graphic images.

66. The method of claim 48, wherein the plurality of graphic images include numerical graphic images, and the step of presenting the plurality of graphic images comprises presenting the plurality of numerical graphic images.

67. The method of claim 48, wherein the plurality of graphic images include icons, and the step of presenting the plurality of graphic images comprises presenting the plurality of icons.

68. A system for enabling an array of multiple graphic images out of a plurality of graphic images to be displayed on a compact display screen mounted in an instrument adapted to be held by the user in one hand, to enable a user to view, focus on and select a selectable graphic image from the array of graphic images in the display screen, and to locate another graphic image in the array of graphic images to be moved into position as the selectable graphic image, wherein the plurality of graphic images are each movable into and out of a position as the selectable graphic image, the system comprising:
a compact display screen mounted in an instrument adapted to be held by the user in one hand;
means for presenting the array of multiple graphic images in the display screen, wherein each graphic image is different from the other graphic images and the multiple graphic images are each movable into and out of a position as the selectable graphic image, comprising a graphical user interface;
means for enabling a graphic image to be a selectable graphic image, which graphic image is movable into the selectable position in the presenting means;
means for enabling the user to view the array of multiple graphic images in the display screen, and to differentiate between the graphic image positioned as the selectable graphic image and the graphic images other than the selectable graphic image in the display screen other than by the differences between the graphic images; and
means for enabling movement of the multiple graphic images into and out of the position as the selectable graphic image, and for enabling selection of the selectable graphic image in the display.

69. The system of claim 68, wherein the graphical user interface comprises means for presenting the array of the multiple graphic images such that the graphic images other than the selectable graphic image are comprised of font sizes which decrease with increasing distance from the selectable graphic image.

70. The system of claim 68, wherein the display screen comprises a bitmap screen.

71. The system of claim 68, wherein the instrument comprises a wireless telephone.

72. The system of claim 68, wherein the multiple graphic images in the array displayed in the display screen comprise at least three graphic images.

73. The system of claim 69, wherein the font size comprises the height of the font, and the differentiating means comprise the height of the fonts of the graphic images other than the selectable graphic image which decrease with increasing distance from the selectable graphic image.

74. The system of claim 69, wherein the multiple graphic images in the array displayed in the display screen comprise at least three graphic images.

75. The system of claim 69, wherein the display screen comprises a bitmap screen.

76. The system of claim 72 wherein the multiple graphic images in the array displayed in the display screen comprises seven graphic images.

77. The system of claim 74 wherein the multiple graphic images in the array displayed in the display screen comprises seven graphic images.

78. A method of enabling an array of multiple graphic images out of a plurality of graphic images to be displayed on a compact display screen mounted in an instrument adapted to be held by the user in one hand, to enable a user to view, focus on and select a selectable graphic image from the array of graphic images in the display screen, and to locate another graphic image in the array of graphic images to be moved into position as the selectable graphic image, wherein the plurality of graphic images are each movable into and out of a position as the selectable graphic image, in a system which comprises a compact display screen mounted in an instrument adapted to be held by the user in one hand, means for presenting the array of the multiple graphic images in the display screen, wherein each graphic image is different from the other graphic images and the multiple graphic images are each movable into and out of a position as the selectable graphic image, comprising a graphical user interface, means for enabling a graphic image to be a selectable graphic image, which graphic image is movable into the selectable position in the presenting means, means for enabling the user to view the array of multiple graphic images in the display screen, and to differentiate between the graphic image positioned as the selectable graphic image and the graphic images other than the selectable graphic image in the display screen other than by the differences between the graphic images, and means for enabling movement of the multiple graphic images into and out of the position as the selectable graphic image, and for enabling selection of the selectable graphic image in the display, the method comprising:
activating the instrument;
presenting the array of graphic images in the display screen;
moving the movement enabling means to move a graphic image into and out of position as the selectable graphic image, wherein movement of a graphic image into position as the selectable graphic image enables the user to select the selectable graphic image; and
activating the movement enabling means to select the selectable graphic image in the display.

79. The method of claim 78, wherein the graphical user interface comprises means for presenting the array of the multiple graphic images such that the graphic images other than the selectable graphic image are comprised of font sizes which decrease with increasing distance from the selectable graphic image, and the step of presenting the array of the plurality of graphic images comprises presenting the graphic images in the array other than the selectable graphic image in font sizes which decrease with increasing distance from the selectable graphic image.

80. The method of claim 78, wherein the display screen comprises a bitmap screen, and the step of presenting the array comprises presenting the array of graphic images in the bitmap screen.

81. The method of claim 78, wherein the instrument comprises a wireless telephone, and the step of activating the instrument comprises activating the wireless telephone.

82. The method of claim 78, wherein the multiple graphic images in the array displayed in the display means comprise at least three graphic images, and the step of presenting the array comprises presenting at least three graphic images in the display screen.

83. The method of claim 79, wherein the font size comprises the height of the font, and the differentiating means comprise the height of the fonts of the graphic images other than the selectable graphic image which decrease with increasing distance from the selectable graphic image, and the step of presenting the array comprises presenting the array of graphic images in the display screen such that the height of the fonts of the graphic images other than the selectable graphic image decrease with increasing distance from the selectable graphic image.

84. The method of claim 79, wherein the multiple graphic images in the array displayed in the display screen comprise at least three graphic images, and the step of presenting the array comprises presenting at least three graphic images in the display screen.

85. The method of claim 79, wherein the display screen comprises a bitmap screen, and the step of presenting the array comprises presenting the array of graphic images in the bitmap screen.

86. The method of claim 82, wherein the multiple graphic images in the array displayed in the display screen comprises seven graphic images, and the step of presenting the array comprises presenting seven graphic images in the display screen.

87. The method of claim 84, wherein the multiple graphic images in the array displayed in the display screen comprises seven graphic images, and the step of presenting the array comprises presenting the seven graphic images in the display screen.

88. A system for enabling manipulation of a plurality of graphic elements on a display screen, to enable a user to form a graphic image in the display screen, the system comprising:
a display screen;
means for presenting an array including a plurality of graphic elements for forming a graphic image in the display screen, and for presenting a line in which the graphic image is to be formed in the display screen, comprising a graphical user interface, wherein the array presenting means and line presenting means intersect at a position in which a graphic element is selectable as a part of the graphic image to be formed;
means for enabling a graphic element to be a selectable graphic element at the intersection of the array presenting means and line presenting means wherein a graphic element is movable into the selectable position; and
means for enabling movement of the array presenting means to move a graphic element into and out of the position as the selectable element in the line for forming the graphic image, and for enabling selection of the selectable graphic element in the display.

89. The system of claim 88, wherein the movement enabling means are rotatable such that rotation thereof results in corresponding rotation of the array presenting means in the display screen.

90. The system of claim 88, wherein the movement enabling means comprise a jog dial which is rotatable and pressable.

91. The system of claim 88, further comprising an instrument in which the display screen is mounted.

92. The system of claim 88, further comprising an instrument in which the display screen is mounted, wherein the instrument is adapted to be held by the user in one hand, and the movement enabling means are adapted to be manipulated by the user with one finger.

93. The system of claim 88, wherein the display screen comprises a liquid crystal display screen.

94. The system of claim 88, wherein the display screen comprises a color display screen.

95. The system of claim 88, wherein the array presenting means are scrollable.

96. The system of claim 88, further comprising means for presenting a picture in the display screen.

97. The system of claim 88, wherein the elements comprise letters, and the graphic image comprises text.

98. The system of claim 88, wherein the array presenting means are oriented generally vertically in the display.

99. The system of claim 88, wherein the line for forming the graphic image is oriented generally horizontally in the display.

100. The system of claim 88, wherein the movement enabling means are further adapted to enable movement of the array presenting means to a position for a selectable graphic element adjacent the selected graphic element position, to enable the adjacent part of the graphic image to be formed.

101. The system of claim 89, wherein the movement enabling means are pressable such that pressing thereof results in selection of the selectable graphic element.

102. The system of claim 89, wherein the array presenting means appear to occupy three-dimensional space.

103. The system of claim 90, further comprising an instrument in which the display screen is mounted, wherein the jog dial is located on a side of the instrument.

104. The system of claim 90, further comprising an instrument in which the display screen is mounted, wherein the jog dial is located in the back of the instrument.

105. The system of claim 92, wherein the instrument comprises a wireless telephone.

106. The system of claim 96, wherein the line presenting means present the line for forming the graphic image in a position below the picture.

107. The system of claim 96, wherein the line formed by the line presenting means comprises a subtitle for the picture.

108. The system of claim 96, further comprising means for taking the picture.

109. The system of claim 96, further comprising means for transmitting the picture and graphic image.

110. The system of claim 97, wherein the elements further comprise numbers.

111. The system of claim 101, wherein the movement enabling means comprise a jog dial which is rotatable and pressable.

112. The system of claim 101, further comprising an instrument in which the display screen is mounted, wherein the instrument is adapted to be held by the user in one hand, and the jog dial is adapted to be manipulated by the user with one hand.

113. The system of claim 102, wherein the line presenting means appear to be a wheel which is rotatable.

114. The system of claim 108, wherein the picture-taking means comprise a CCD camera.

115. The system of claim 109, wherein the line presenting means present the letters in lower and upper case, and present the lower and upper case letters and numbers in sequence.

116. The system of claim 111, further comprising an instrument in which the display screen is mounted, wherein the jog dial is located on a side of the instrument.

117. The system of claim 111, further comprising an instrument in which the display screen is mounted, wherein the jog dial is located in the back of the instrument.

118. The system of claim 112, wherein the jog dial is adapted to be manipulated by the thumb of the user.

119. The system of claim 113, wherein the jog dial is adapted to be manipulated by the forefinger of the user.

120. A method of enabling manipulation of a plurality of graphic elements on a display screen, to enable a user to form a graphic image in the display screen, the method comprising:
activating a display screen in a system which includes the display screen, means for presenting an array including a plurality of graphic elements for forming a graphic image in the display screen, and for presenting a line in which the graphic image is to be formed in the display screen, comprising a graphical user interface, wherein the array presenting means and line presenting means intersect at a position in which a graphic element is selectable as a part of the graphic image to be formed; means for enabling a graphic element to be a selectable graphic element at the intersection of the array presenting means and line presenting means wherein a graphic element is movable into the selectable position; and means for enabling movement of the array presenting means to move a graphic element into and out of the position as the selectable graphic element in the line for forming the graphic image, and for enabling selection of the selectable graphic element in the display;
presenting the array presenting means and line presenting means in the display;
moving the movement enabling means to move a graphic element into and out of position as the selectable graphic element, wherein movement of a graphic element into position as the selectable graphic element enables the user to select the selectable graphic element; and
activating the movement enabling means to select the selectable graphic element in the display.

121. The method of claim 120, wherein the movement enabling means are rotatable such that rotation thereof results in corresponding rotation of the array presenting means in the display screen, and the steps of moving and activating the movement enabling means comprises rotating the movement enabling means and selecting the selectable graphic element.

122. The method of claim 120, wherein the movement enabling means comprise a jog dial which is rotatable and pressable, and the steps of moving and activating the movement enabling means comprises activating the jog dial.

123. The method of claim 120, further comprising an instrument in which the display screen is mounted, wherein the instrument is adapted to be held by the user in one hand, and the movement enabling means are adapted to be manipulated by the user with one hand, and the steps of moving and activating the movement enabling means comprise manipulating the movement enabling means with one hand of the user.

124. The method of claim 120, wherein the display screen comprises a liquid crystal display screen, and the step of activating the display screen comprises activating the liquid crystal display screen.

125. The method of claim 120, wherein the display screen comprises a color display screen, and the step of activating the display screen comprises activating the color display screen.

126. The method of claim 120, wherein the array presenting means are scrollable, and the step of moving the movement enabling means comprises scrolling the array presenting means.

127. The method of claim 120, wherein the system further comprises means for presenting a picture in the display screen, further comprising the step of activating the picture presenting means to present the picture in the display screen.

128. The method of claim 120, wherein the graphic elements comprise letters, and the graphic image comprises text, and the step of presenting the graphic image array comprises presenting the graphic elements letter for forming the graphic image text.

129. The method of claim 120, wherein the array presenting means are oriented generally vertically in the display, and the step of presenting the graphic element array comprises presenting the array in a generally vertical orientation in the display.

130. The method of claim 120, wherein the line presenting means are oriented generally horizontally in the display, and the step of presenting the graphic image comprises presenting the image in a generally horizontal orientation in the display.

131. The method of claim 120, wherein the movement enabling means are further adapted to enable movement of the array presenting means to a position for a selectable graphic element adjacent the selected graphic element position, to enable the adjacent part of the graphic image to be formed, further comprising the step of moving the graphic element array to the position adjacent the selected graphic element.

132. A system for enabling automatic performance of functions of an instrument, comprising:
means for enabling entry in the instrument of information relating to a party, and information associated with the related information; and
means for performing automatically a function in connection with the related information and the associated information.

133. The system of claim 132, wherein the related information comprises the telephone number of a party, the instrument comprises a wireless telephone, further comprising a display screen, and means for displaying the entered telephone number on the display screen, and wherein the associated information comprises the name of the party associated with the entered telephone number, and the automatic function comprises automatically displaying the entered name of the party associated with the telephone number along with the entered telephone number on the display.

134. The system of claim 132, further comprising means for connecting the instrument to the telephone number entered, wherein the instrument comprises a paging instrument, the telephone number of the party comprises the telephone number of a paging service, the associated information comprises a personal identification number, and the automatic function comprises automatically transmitting the personal identification number to the connected paging service number.

135. The system of claim 134, further comprising a display screen, and means for displaying the entered paging service telephone number on the display.

136. The system of claim 134 wherein the displaying means are further adapted to display the personal identification number.

137. A method of enabling automatic performance of functions of an instrument in a system which comprises means for enabling entry in the instrument of information relating to a party, and information associated with the related information, and means for performing automatically a function in connection with the related information and the associated information, the method comprising:
entering the related information and associated information in the instrument; and
automatically performing the function in connection with the related information on the associated information.

138. The method of claim 137, wherein the related information comprises the telephone number of a party, the instrument comprises a wireless telephone, further comprising a display screen, and means for displaying the entered telephone number on the display screen, and wherein the associated information comprises the name of the party associated with the entered telephone number, and the automatic function comprises automatically displaying the entered name of the party associated with the telephone number along with the entered telephone number on the display, further comprising the step of displaying the entered name of the party associated with the entered telephone number along with the entered telephone number.

139. The method of claim 137, further comprising means for connecting the instrument to the telephone number entered, wherein the instrument comprises a paging instrument, the telephone number of the party comprises the telephone number of a paging service, the associated information comprises a personal identification number, and the automatic function comprises automatically transmitting the personal identification number to the connected paging service number, further comprising the steps of connecting the instrument to the entered paging service telephone number, and automatically transmitting the personal identification number to the connected paging service number.

140. The method of claim 139, wherein the instrument further comprises a display screen, and means for displaying the entered paging service telephone number on the display screen, further comprising the step of displaying the entered paging service number on the display screen.

141. The method of claim 139, wherein the displaying means are further adapted to display the personal identification number, further comprising the step of displaying the entered personal identification number on the display screen.
